(19) United States
(12) Patent Application Publication
(10) Pub. No.: US 2004/0225510 A1
(43) Pub. Date: Nov. 11, 2004

(54) Method and software for facilitating a purchase

(76) Inventor: Glen E. McGovern, Carmel, IN (US)

Correspondence Address: BOSE MCKINNEY & EVANS LLP, 135 N PENNSYLVANIA ST, SUITE 2700, INDIANAPOLIS, IN, 46204, US

(21) Appl. No.: 10/431,416

(22) Filed: May 7, 2003

(51) Int. Cl. G06F 17/60

(52) U.S. Cl. 705/1

(57) ABSTRACT

A method and software used for facilitating a purchase, including an account designated by a consumer for a specific purchase. The account is configured to receive deposits from the consumer. The consumer receives a discount on the purchase from a vendor of the item designated for purchase. The discounts are related to the deposits in the account.

### FIELD OF THE INVENTION

This invention relates generally to a method of facilitating a purchase of an item or service. More particularly, the invention relates to a method and software for facilitating a purchase wherein a consumer selects an item or service to purchase, an account is configured to receive deposits from the consumer toward the purchase, and a vendor provides discounts to the consumer in association with deposits to the account.

### BACKGROUND

There are situations where an individual or group knows that he, she or it will be incurring a large expense in connection with a purchase of items or services at some future date. A common way of facilitating such future purchases is by periodically saving a certain amount of money and/or investing that money. In this manner, funds are available to make the purchase at the desired time. This approach, however, has several drawbacks. Savings accounts typically have a low interest rate, which provides consumers a small return on their investment. Further, the consumer must also pay taxes on the interest earned by their savings accounts.

Another common way of facilitating a purchase is by financing the purchase after taking possession of the items or receiving the services. This approach, however, also has disadvantages. There is little flexibility for missing payments. In many cases, missed payments result in repossession of the item and/or harm to the consumer's credit. Also, consumers may be more likely to overextend themselves by financing rather than paying for an item or service at the time of purchase.

Accordingly, there is a need for a method of facilitating purchases that provides a high return on investment, a tax-free investment, and requires no mandatory monthly payments.

### SUMMARY OF THE INVENTION

The invention relates to a method for purchasing an item or service at a future date wherein an account is established for a consumer, the consumer pre-selects a product or a service, deposits by the consumer are monitored, each deposit is associated with a discount, and the discounts are used to lower the price of the item or service upon withdrawal of the deposits from the account to make the pre-selected purchase.

The invention also relates to a computer program configured to establish an account, receive input from a consumer regarding the type of a purchase they will be making, monitor deposits from the consumer into the account, match each deposit to a discount, and release funds to a consumer for a purchase.

According to one embodiment of this invention, a method of facilitating a purchase is provided including the steps of establishing an account, having a consumer designate an item or service they plan to purchase at a later date, receiving deposits into the account from the consumer, associating each deposit with a discount from a vendor, and releasing the funds to the consumer when the consumer is ready to make the purchase. The method may further include the steps of defining a relationship between the consumer and a lender and defining a relationship between the consumer and a vendor. Additionally, the method includes the steps of providing the consumer a list of vendors and requiring the consumer to designate a vendor for the purchase from the list of vendors.

According to another embodiment of this invention, a computer program for monitoring a purchase is provided, which includes a computer usable medium, a computer readable code embodied on the computer usable medium, the computer usable code including a plurality of computer readable code sections configured to perform the following functions: establish an account, receive over a communication network input from a user selecting either a product or service, make a selection of either the product or the service, monitor deposits into the account, match each deposit to a discount, and release the deposits to the consumer in the form of a voucher. The code sections may also be configured to facilitate changes in the selected purchase by receiving an input from either a user or the consumer.

Additional features of the present invention will become apparent to those skilled in the art upon consideration of the following detailed description when taken in conjunction with the accompanying drawings.

### BRIEF DESCRIPTION OF THE DRAWINGS

The detailed description particularly refers to the accompanying figures in which:

FIG. 1 is a conceptual diagram of a method and software according to one embodiment of the present invention;

FIG. 2 is a table illustrating an example of the financial effects of the present invention;

FIG. 3 is a table illustrating levels of discounts associated with deposits made to an account;

FIG. 4 is a table illustrating an example of reimbursements to a vendor;

FIG. 5 is a table showing an alternative embodiment of the composition of the discounts earned based on levels of deposits made to an account;

FIG. 6 is a conceptual diagram of software according to the present invention and the interaction of a consumer, user, and/or an operator on a computer using the software;

FIG. 7 is a conceptual diagram of the software of FIG. 6, and the various functions of each of the code sections.

### DETAILED DESCRIPTION OF THE EMBODIMENTS OF THE INVENTION

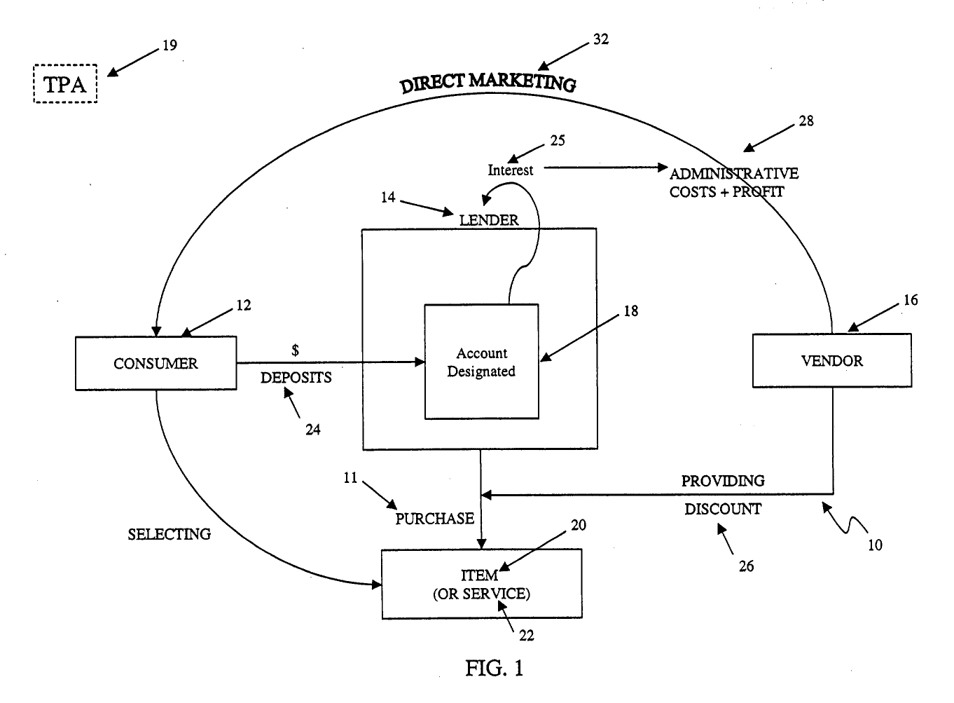

FIG. 1 illustrates a system 10 for facilitating a purchase 11 of an item 20 such as a vehicle, financial instrument, appliance, etc. or service 22 (hereinafter collectively referred to as an item 20). The system 10 establishes a relationship between a consumer 12 and a lender 14, and between the consumer 12 and a vendor 16. It should be understood that the consumer 12 could be an individual, a company or an entity, and the lender 14 could be any lending institution including a bank, a credit union, a brokerage firm, or any other entity or individual, even if the entity or individual does not lend money in the ordinary course of business.

According to an embodiment of the invention, the consumer 12 agrees to make the purchase 11 of the item 20 from the vendor 16 at a future date. In exchange for the future sale of the item 20, the vendor 16 provides a discount 26 to the consumer 12. The discount 26 lowers the overall cost of the item 20.

An account 18 is created with the lender 14. The account 18 is configured to receive deposits 24 and earn interest 25. The account 18 can be any type of financial account such as a savings account, a checking account, a certificate of deposit, a money market account, a bond, a T-bill or a T-note. The account 18 may or may not be FDIC insured.

More particularly, the consumer 12 establishes the account 18 with the lender 14. The consumer 12 may establish the account 18 with the lender 14 in person, on the telephone, over the World Wide Web, or using some other mode of communication. As should be apparent to one skilled in the art, a Third Party Administrator (TPA) 19 could also aid the consumer 12 in establishing the account 18 with the lender 14.

After establishing the account 18 with the lender 14, the consumer 12 designates the purchase 11 to be made using money in the account 18. After establishing the account 18 and designating the purchase 11, the consumer 12 makes deposits 24 into the account 18. The deposits 24 can be made at any time so long as at least one deposit is made. The deposits 24 can be daily, monthly, yearly, or any other periodic or non-periodic interval. As further defined below, the vendor 14 provides discounts 26 for use by the consumer 12 in making the purchase 11. The discounts 26 by the vendor 14 correspond to the value and/or frequency of deposits 24. As further described below, depending upon the configuration of the account, deposits in excess of a predetermined amount or in excess of a predetermined number or frequency may not earn discounts 26. The balance of the account 18 earns interest 25, which may accrue daily, monthly, yearly, or at any other frequency. In one embodiment, the interest in the account 18 continues to accrue for a predefined time period after a final deposit into the account 18. As is further described below, each deposit 24 into the account 18 may be associated with a discount. The interest may be included as part of any such discount. All or part of the interest 25 may be credited to the account 18 as an additional discount 26, or be provided to the lender 14, the vendor 16, or the TPA 19 to cover administrative costs and/or provide profits 28.

As indicated above, after the consumer 12 establishes the account 18, the consumer 12 must designate the purchase 11 for which the account 18 will be used. The consumer 12 may designate the purchase 11 from a particular vendor 16 or from a list of participating vendors 16 generated by, for example, the TPA 19. Thus, the consumer 12 may select a vendor 16 as the designated vendor 16 associated with the account 18, and chose a specific item 20 provided by the designated vendor 16 at a time closer to making the purchase 11. When the consumer 12 designates a vendor 16, thereby establishing a relationship with the vendor 16 (whether or not the consumer 12 also designates a specific item 20), the vendor 12 may provide direct marketing 32 to the consumer 12 regarding other items 20. For example, the vendor 16 may provide literature to the consumer 12, provide additional discounts 26 on items 20, or simply discuss with the consumer 12 advantages and disadvantages of specific items 20 offered by the vendor 16. In one embodiment, the consumer 12 is an individual, the lender 14 is a bank, and the vendor 16 is an automotive dealer. To make the purchase 11, the consumer 12 may receive a voucher, a payment coupon, cash, a check, or a money order, as further described below.

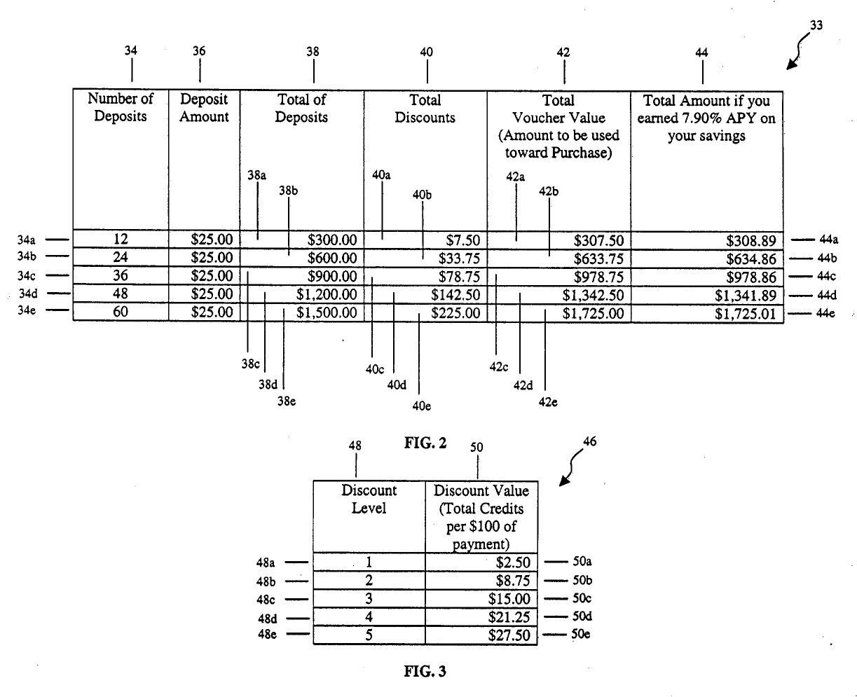

FIG. 2 includes a Table 33, which depicts an example of activity in an account 18 using a method for facilitating a purchase 11 according to the present invention. Table 33 includes the following columns: number of deposits (column 34), deposit amounts (column 36), total deposits (column 38), total discounts (column 40), and total voucher value (column 42). Column 44 of Table 33 lists balance amounts of a savings account with a 7.9% annual percentage yield (APY) for comparison to the total voucher values (column 42).

The number of deposits (column 34) made into the account 18 may vary. For ease of discussion, the number of deposits (column 34) is shown as twelve deposits, twenty-four deposits, thirty-six deposits, forty-eight deposits, or sixty deposits (cells 34a-34e, respectively). In this example, the deposit amount (column 36) is a constant $25.00 per deposit 24. It should be understood, however, that the deposit amount (column 36) can be any value and can be different for each of the number of deposits (column 34). The total deposits (column 38) are the number of deposits (column 34) multiplied by the deposit amounts (column 35). For twelve deposits, the total deposit is $300 (cell 38a). Twenty-four deposits yield $600 (cell 38b). Thirty-six deposits yield $900 (cell 38c). Forty-eight deposits yield $1200 (cell 38d). Similarly, sixty deposits yield $1500 (cell 38e).

In this example, the total discounts (column 40) are the discounts 26 on the purchase 11 given by the vendor 16 to the consumer 12. For example, for the first twelve deposits, the vendor 16 gives the consumer 12 a discount of $7.50 (cell 40a). For twenty-four deposits, the vendor 16 gives the consumer 12 a total discount of $33.75 (cell 40b). The discount of $33.75 (cell 40b) is the total of the $7.50 discount (cell 40a) for the first twelve deposits plus $26.25 for deposits thirteen through twenty-four. For thirty-six deposits, the vendor 16 gives the consumer 12 a total discount of $78.75 (cell 40c). The discount of $78.75 (cell 40c) is the total of the $33.75 discount (cell 40b) plus $45.00 for deposits twenty-five through thirty-six. For forty-eight deposits, the vendor 16 gives the consumer 12 a total discount of $142.50 (cell 40d). The discount of $142.50 (cell 40d) is the total of the $78.75 discount (cell 40c) plus $63.75 for deposits thirty-seven through forty-eight. For sixty deposits, the total discount is $225.00 (cell 40e). The discount of $225.00 (cell 40e) is the total of the $142.50 discount (cell 40d) plus $82.50 for deposits forty-nine through sixty.

In this example, the total voucher value (column 42) is the sum of the total deposit (column 38) and the total discounts (column 40). For example, twelve deposits yield a total voucher value of $307.50 (cell 42a). The remaining cells 42b-42e in column 40 are calculated in a similar manner.

Column 44 shows the value that the same total deposits (column 38) would earn if the consumer 12 invested in a typical savings account with an APY of 7.90%. For a total deposit of $300.00 (cell 38a), the equivalent value in a savings account would be $308.89 (cell 44a). For a total deposit of $600.00 (cell 38b), the equivalent value in a savings account would be $634.86 (cell 44b). For a total deposit of $900.00 (cell 38c), the equivalent value in a savings account would be $978.75 (cell 44c). For a total deposit of $1200.00 (cell 38d), the equivalent value in a savings account would be $1342.50 (cell 44d). For a total deposit of $1500.00 (cell 38e), the equivalent value in a savings account would be $1725.01 (cell 44e).

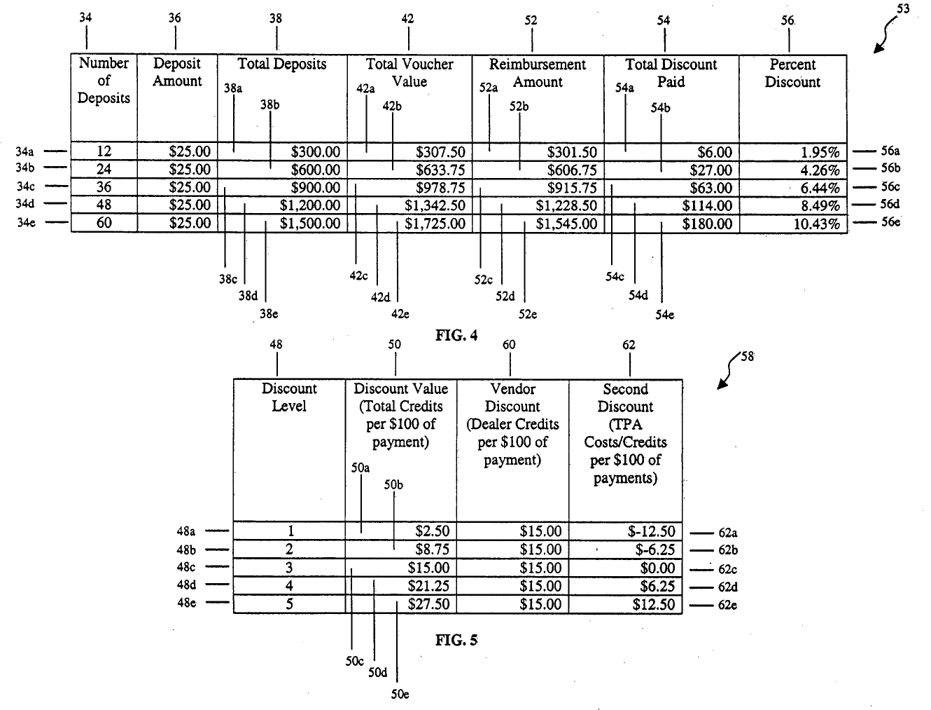

FIG. 3 includes a table 46, which depicts levels of discounts associated with deposits 24 to the account 18. Table 46 includes a discount level column 48 and a discount value column 50. In this embodiment, there are five discount levels 48 (levels 1-5) as shown in cells 48a-e, respectively. In alternative embodiments, fewer than five discount levels or more than five discount levels are used. Each discount level (column 48) has a corresponding discount value shown in column 50. The discount values of column 50 are applied to increments of $100 of deposits. In one embodiment, the level 1 (cell 48a) discount value is $2.50 (cell 50a), the level 2 (cell 48b) discount value is $8.75 (cell 50b), the level 3 (cell 48c) discount value is $15.00 (cell 50c), the level 4 (cell 48d) discount value is $21.25 (cell 50d), and the level 5 (cell 48e) discount value is $27.50 (cell 50e). Although Table 46 shows discount values (column 50) that increase from each discount level (column 48) to the next discount level, in other embodiments, discount values (column 50) are the same for each level, decrease from level to level, or are arbitrary. Moreover, the $100 deposit could be higher or lower in alternative embodiments. In this example, the consumer 12 must make twelve deposits 24 (column 34 of FIG. 2) to move from one level to the next level. The twelve deposits 24 can be made in any combination of daily, monthly or yearly deposits, depending on the predetermined frequency. In alternative embodiments, the consumer 12 may be required to make more or fewer than twelve deposits 24 to move to the next discount level (column 48).

Referring to FIGS. 1-3, the total discounts (column 40) earned by the consumer 12 are computed by multiplying the discount value $2.50 (cell 50a) associated with the first level (cell 48a) by the total deposits (cell 38a) and dividing by 100. After the consumer 12 makes the first number of deposits (cell 34a), the discounts associated with the next number of deposits are computed by multiplying the discount value of $8.75 (cell 50b) associated with the second level (cell 48b) by the total deposits shown in cell 38b (less the amount shown in cell 38a), and dividing by 100. Cell 40b reflects the $7.50 in discounts earned for the first twelve deposits and the $26.25 in discounts earned for the second twelve deposits. The remaining total discounts (cells 40c-40e) shown in column 40 are calculated in a similar fashion.

The total voucher value amounts shown in column 42 of FIG. 2 are the sum of the total discounts (column 40) and the respective total deposits (column 38). When the consumer 12 is ready to make a purchase 11, the lender 14 or TPA 19 issues a voucher for the appropriate total voucher value (column 42) depending upon the total deposits 24 made to the account 18. The consumer 12 uses the voucher to pay for the item 20 from the vendor 16, or applies the voucher toward the payment price. In an alternative embodiment, the lender 14 or TPA 19 issues vouchers from the account 18 for each deposit 24.

FIG. 4 is similar to FIG. 2, showing the same number of deposits (column 34), deposit amount (column 36), total deposits (column 38), and total voucher value (column 42). FIG. 4 also lists the amounts the vendor 16 actually receives (column 52) when the vendor 16 cashes in vouchers after various levels of deposits have been made. The interest earned by the lender on the total deposits (e.g., $300.00 in cell 38a) is used along with the total deposit to pay the reimbursement amount (e.g., $301.50 in cell 52a). Any interest earned by the lender in excess of the difference between the reimbursement amount (column 52) and the respective total deposits (column 38) may be used for expenses incurred by the lender, profits, or additional discounts. The reimbursement amount shown in column 52 is lower than the total voucher value of column 42. The total discount paid (column 54) is the difference between the total voucher value (column 42) and the reimbursement amount (column 52). The percent discount (column 56) is the percentage of the total voucher amount the vendor 16 pays as a discount (i.e., column 54 entries divided by column 42 entries multiplied by 100). The percent discount (column 56) increases as the number of payments (column 34) increases because the level of the discounts increases as shown in column value 50 of FIG. 3.

Table 58 of FIG. 5 shows an alternative discount composition. Columns 48 and 50 of Table 58 are identical to columns 48 and 50 of Table 46 of FIG. 3. Table 58 also includes a vendor discount (column 60) and a second discount (column 62). The second discount (column 62) is provided by either the lender 14 or the TPA 19, and can be a negative discount or cost. In the discount composition shown in FIG. 5, the discount value (column 50) is the sum of the vendor discount (column 60) and the second discount (column 62). Also shown, the vendor discount (column 60) is a constant for each level (column 48), and the second discounts (column 62) increase. It should be understood that the vendor discount (column 60) could also vary.

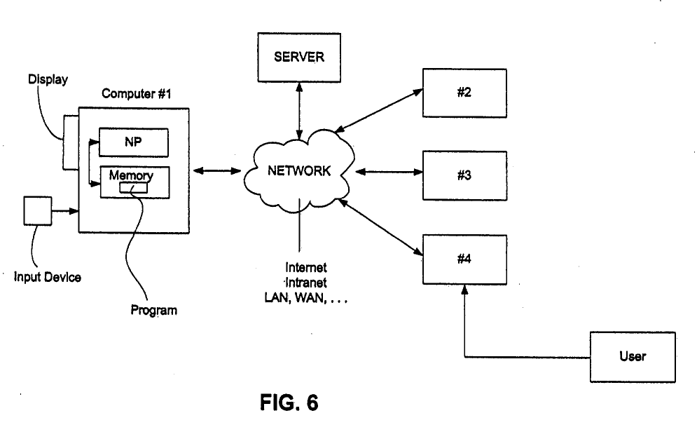

Referring now to FIG. 6, a system 63 for facilitating a purchase 11 is shown. The computer program system 63 includes at least one computer 68a configured to run a computer program 65. The first computer 68a includes a display 66, an input device 67, a processor 69 and a memory 70. The program 65 is stored on the memory 70. The memory 70 is a computer usable medium such as a CD-ROM, floppy disk, hard drive, or any other suitable storage media.

Additionally, the system 63 includes a server 71 and a network 72. In one embodiment, the system 63 also includes a second computer 68b, a third computer 68c and a fourth computer 68d. The network 72 connects the server 71 and computers 68a-68d to one another. The network 72 can be any known network system such as the Internet, an intranet, a LAN, a WAN, or any other suitable network system. It should be understood that the system 63 may include only a single computer 68a or it may include a plurality of computers, each computer either having the program 65 or having access to the program 65 stored in a memory 70 through the network 72. In other embodiments, the program 65 may reside in whole or in part on the server 71, each of the computers 68a-68d accessing data relating to purchases II and performing other operations (e.g., making deposits, updating accounts, obtaining discounts, etc.) by accessing server 71 via network 72.

In one example, a user 73 makes a connection to a computer 68d. The user 73 either makes the connection from another computer to the computer 68d or the user 73 indirectly makes a connection through interaction with the lender 14. The user 73 may be the consumer 12 or a person acting on behalf of the consumer 12 such as a TPA 19. The user 73 provides input to the program 65 when needed by the program 65 as further described below.

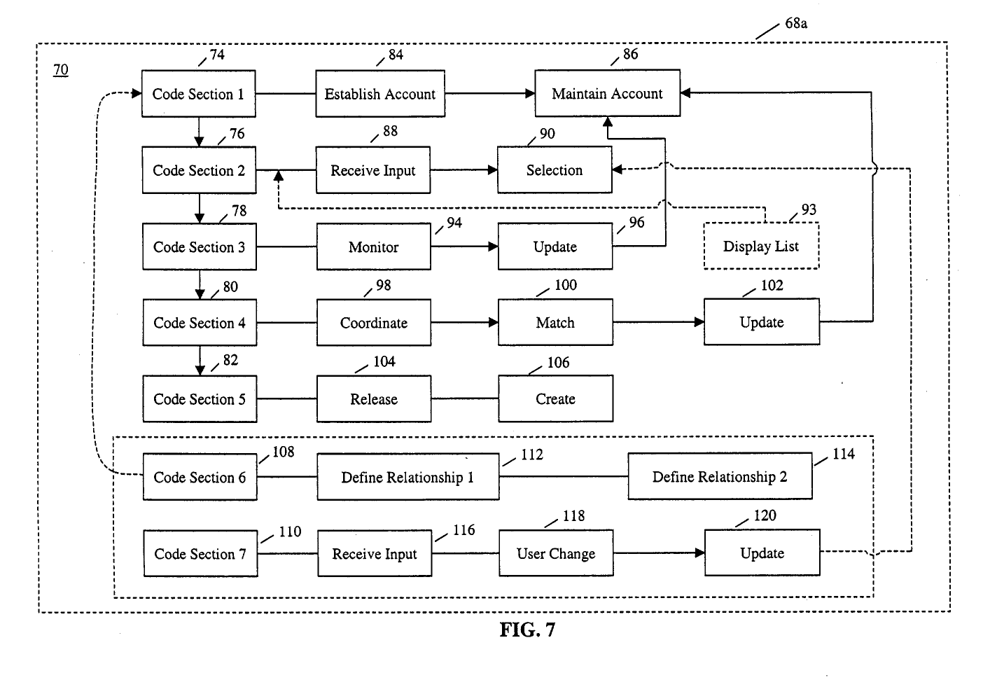

FIG. 7 shows various steps carried out by program 65. A first code section 74 causes the computer 68a to establish account 18 (step 84) and maintain the account 18 (step 86). A second code section 76 enables the computer 68a to receive inputs (step 88) over the network 72 from the user 73. The inputs are used to determine the selection of an item 20 (step 90) by the user 73. If no network 72 is used, the computer 68 receives input from the user 73 through the input device 67 shown in FIG. 6. The second code section 76 may also include the optional function of showing a list (step 93) on the display 66. The list may include a catalog of items 20 or vendors 16. A third code section 78 monitors a plurality of deposits 24 made into the account 18 (step 94) and updates the first code section 74 (step 96). A fourth code section 80 functions to coordinate each deposit 24 made into the account 18 (step 98), to match each deposit 24 to a discount 26 (step 100), and to update the first code section 74 (step 102). A fifth code section 82 releases the funds in the account 18 (step 104) to the consumer 12 by creating a voucher (step 106).

A sixth code section 108 and a seventh code section 110 are options to the program 65. The sixth code section 108 updates the first code section 74 with information relating to a first relationship defined in step 112 and a second relationship defined in step 114. The sixth code section 108 stores this information regarding the relationships. The relationship defined in step 112 may be the relationship between the consumer 12 and the lender 14. The relationship defined in step 114 may be the relationship between the consumer 12 and at least one vendor 16. The user 73 provides the information stored in the sixth code section 108 directly through input device 67, or indirectly via a computer 68b-68d and network 72 or to another person who enters the information into one of computers 68a-68d. The lender 14, the vendor 16 and the consumer 12 share the stored information for direct marketing 32. The seventh code section 110 receives input from the user 70 in step 116 indicating a change 116 in the selected item 20. The seventh code section 110 uses this input to update the selection step 90 of the second code section 76.

Although the invention has been described in detail with reference to certain illustrated embodiments, variations and modifications exist within the spirit and scope of the present invention as described and defined in the following claims.

1. A method of facilitating a purchase including the steps of:
establishing an account for receiving deposits from a consumer;
requiring the consumer to designate a purchase as an intended use of the account;
receiving deposits into the account;
associating with each deposit a discount toward the purchase; and
releasing the deposits to the consumer to make the designated purchase for a price that is reduced by the discounts associated with the deposits.

2. The method of claim 1, wherein the establishing step includes the steps of defining a relationship between the consumer and a lender and defining a relationship between the consumer and at least one vendor.

3. The method of claim 2, wherein the lender is a bank.

4. The method of claim 2, wherein the lender is a brokerage firm.

5. The method of claim 2, wherein the vendor is an automotive dealership.

6. The method of claim 1, wherein the receiving step includes receiving deposits at least one time per year.

7. The method of claim 1, wherein the receiving step includes receiving deposits up to a maximum total account value.

8. The method of claim 1, wherein the deposits are limited to one of a specific size and a range.

9. The method of claim 1, wherein the number of deposits are limited to a predetermined number.

10. The method of claim 1, wherein the requiring step includes the steps of providing the consumer a list of vendors, and requiring the consumer to designate a vendor for the purchase from the list of vendors.

11. The method of claim 10 further comprising the step of providing the designated vendor information about the consumer to enable the vendor to solicit other purchases from the consumer.

12. The method of claim 10, wherein the purchase is a purchase of an automobile.

13. The method of claim 1, wherein the account is one of a savings account, a checking account, a money market account, a bond, a T-bill, a T-note, a mutual fund, and a certificate of deposit.

14. The method of claim 13, wherein the account is an FDIC insured account.

15. The method of claim 1, wherein the account accrues interest.

16. The method of claim 15, wherein the interest in the account continues to accrue during a time period after a final deposit.

17. The method of claim 16, wherein the number of deposits are limited to a predetermined number.

18. The method of claim 15, wherein the discounts associated with the deposits include the interest accrued in the account.

19. The method of claim 15, wherein the interest accrues for a predetermined time period.

20. The method of claim 1, wherein each discount toward the purchase includes a coupon provided by a vendor of the designated purchase.

21. The method of claim 20, wherein a discount also includes a manufacture discount toward the purchase.

22. The method of claim 1, wherein each discount is a dollar amount based on one of a size of the associated deposit, a number of deposits, and a balance of the account.

23. The method of claim 1, wherein each discount is limited to a predetermined maximum amount.

24. The method of claim 1, further including the step of providing the consumer an option of changing a designated vendor for the designated purchase from a first vendor to a second vendor.

25. The method of claim 1 further including the step of providing the consumer an option of changing the designated purchase to a different designated purchase.

26. The method of claim 25, wherein the providing step includes the step of charging the consumer a fee.

27. The method of claim 1, further including the step of charging the consumer a fee in the event the deposits are released to the consumer, but not used to make the designated purchase.

28. The method of claim 1, wherein the associating step includes the step of transferring a discount from a vendor of the designated purchase to a lender after each deposit is received into the account.

29. A method of facilitating a purchase including the steps of:
establishing an account for receiving deposits from a consumer;
requiring the consumer to designate a purchase as an intended use of the account;
monitoring deposits from the consumer into the account;
associating with each deposit a discount toward the purchase; and
providing the consumer the discounts associated with the deposits to reduce a price for the designated purchase upon withdrawal of the deposits from the account to make the designated purchase.

30. The method of claim 29, wherein the establishing step includes the steps of defining a relationship between the consumer and a lender and defining a relationship between the consumer and at least one vendor.

31. The method of claim 29, wherein the receiving step includes receiving deposits at least one time per year.

32. The method of claim 29, wherein the receiving step includes receiving deposits up to a maximum total account value.

33. The method of claim 29, wherein the requiring step includes the steps of providing the consumer a list of vendors, and requiring the consumer to designate a vendor for the purchase from the list of vendors.

34. The method of claim 33 further comprising the step of providing the designated vendor information about the consumer to enable the vendor to solicit other purchases from the consumer.

35. The method of claim 29, wherein the account accrues interest.

36. The method of claim 29, wherein each discount toward the purchase includes a coupon provided by a vendor of the designated purchase.

37. The method of claim 29, wherein each discount is a dollar amount based on one of a size of the associated deposit, a number of deposits, and a balance of the account.

38. A computer program for monitoring a purchase of one of a product and a service by a consumer, the computer program including:
a first code section configured to cause the computer to establish an account;
a second code section configured to receive over a communication network input from a user selecting one of the product and the service;
a third code section configured to monitor a plurality of deposits into the account; a fourth code section configured to match each of the plurality of deposits to a discount, said discount being predetermined by an operator; and
a fifth code section configured to release the deposits to the consumer in the form of a voucher.

39. The computer program of claim 38, further including an additional code section configured to define one of a relationship between the consumer and a lender and a relationship between the consumer and at least one vendor.

40. The computer program of claim 38, wherein the second code section further includes a list of vendors and is configured to receive an input from the consumer, the input corresponding to a selection of one of the vendors from the list of vendors for the purchase.

41. The computer program of claim 38, further including an additional code section configured to receive input from the user re-designating one of the product and the service to a different designated purchase.

42. A system for facilitating a purchase, including:
a computer having a microprocessor configured to execute a program stored in a memory; and
an account associated with a consumer;
wherein the program is configured to monitor deposits from the consumer into the account toward the purchase of one of an item and a service designated by the consumer, and to associate discounts toward the purchase with the deposits, the discounts being provided by a vendor of the designated item or service.

43. The system of claim 42 further including a server connected to the computer via a network, the account being maintained on the server.
